(19) United States
(12) Patent Application Publication
(10) Pub. No.: US 2010/0314203 A1
(43) Pub. Date: Dec. 16, 2010

(54) Method for the assembly of a wear indicator on a brake

(76) Inventors: Hartmut Kohler, Pfalzgrafenweiler (DE); Marco Schock, Renningen (DE); Jorg Korecki, Aidlingen (DE)

Correspondence Address: LAMBERT & ASSOCIATES, 92 STATE STREET, BOSTON, MA, 02109-2004, US

(21) Appl. No.: 12/085,236

(22) PCT Filed: Nov. 16, 2006
(86) PCT No.: PCT/EP2006/011002

§ 371 Date: Apr. 14, 2009

(30) Foreign Application Priority Data
Nov. 18, 2005 (DE) 10 2005 055 536.

(51) Int. Cl. F16D 66/02; B23P 19/00; G01L 5/28

(52) U.S. Cl. 188/1.11 L; 29/700; 73/121

(57) ABSTRACT

Disclosed is a method for assembling a wear indicator on a brake, especially a drum brake. According to said method, a loop is to be formed in the warning conductor of the wear indicator, said loop is to be inserted through a recess in a lining support near a friction lining or between two friction linings, whereupon an insulating piece is to be hooked into the loop, and the insulating piece is to be inserted, particularly, snapped, into the recess.

The invention concerns a method for installing a wear indicator on a brake, especially a drum brake for a vehicle, with at least one friction lining on a lining support, a wear indicator with a warning conductor being connected to the friction lining.

### PRIOR ART

Such brakes, as well as wear indicators, are known and common in a variety of forms and embodiments. For example, a disk brake and a monitoring device for such a disk brake, especially for its wear, are described in DE 103 56 801. Here, the monitoring device has a measurement element, movable with reference to a brake saddle, which is supported on an end surface of a pressure spindle facing away from the brake disk, which presses against a brake lining. The measurement element measures the relative position of the pressure spindle to the brake lining and can thus establish wear phenomena.

A shortcoming here, however, is that this monitoring device has an intricate design, which hampers handling of the monitoring device, and also replacement of individual components. Contact between the brake lining and pressure spindle, as well as between the pressure spindle and measurement element, must be constantly guaranteed. However, if the nut, into which the pressure spindle is screwed, is tilted, or the spring for biasing the measurement element is damaged, the monitoring device can no longer record the state of wear.

### TASK

The task of the present invention is to significantly facilitate mounting of a wear indicator, as well as its handling. At the same time, the wear indicator is supposed to take up less space and guarantee accurate recording of the state of wear of the brake.

### SOLUTION FOR THE TASK

The fact that a loop is formed in the warning conductor of the wear indicator and this extends through a recess in a lining support next to a friction lining or between two friction linings, whereupon an insulation piece is suspended in the loop and the insulation piece inserted into the recess, especially clipped in, leads to a solution of the task. This mounting is extremely simple and requires very little time. Via the insulation piece and its height, the dimension, up to which the friction linings can be worn before a signal to replace the friction lining is given, is also simultaneously determined.

In a preferred practical example, the warning conductor is supposed to be still enclosed by a flexible tube that acts as force accumulator. After the tube has been positioned around the insulation piece, the tube stands against the insulation piece. The insulation piece is not clipped into the recess and the pressure force acting on the tube is released, so that the tube expands and the tube is then tightened on the insulation piece.

A corresponding brake, in which the warning conductor is passed in a loop around the insulation piece and this is clipped into a recess in the lining support next to the friction lining, is included by the invention. The recess should then be situated in a gap between two friction linings, which is true, especially for drum brakes.

In order for the loop to be held on the insulation piece, this should have a groove, into which the loop is inserted. This groove, in one practical example, can run in a plane around the insulation piece, but it is also possible that the groove runs across this plane.

The insulation piece itself is a very simply designed part. It preferably consists of an arrow-shaped base element protruding from the lining support, this base element having an external dimension greater than the recess. This avoids a situation in which the base element slides through the recess and instead the base element is supported against the lining support and spans the recess.

However, flexible clip feet protrude from the base element, which can be pushed through the recess. These clip feet have additional snap tabs that can engage behind the edges of the recess.

### DESCRIPTION OF FIGURES

Additional advantages, features and details of the invention are apparent from the following description of preferred practical examples, as well as with reference to the drawings; in the drawing

FIG. 1 shows a top view of a wear indicator;

FIG. 2 shows a side view of an insulation piece according to the invention;

FIG. 3 shows another side view of the insulation piece according to FIG. 2, rotated by 90°;

FIG. 4 shows a top view of the insulation piece according to FIG. 2;

FIG. 5 shows a side view of another practical example of an insulation piece;

FIG. 6 shows a top view of the insulation piece according to FIG. 5;

FIG. 7 shows a top view of a part of a drum brake.

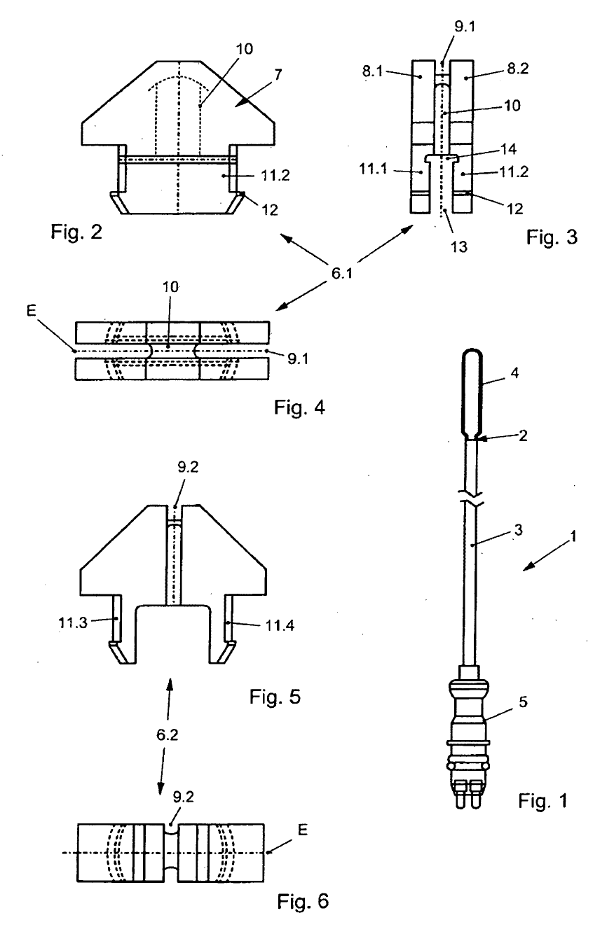

A wear indicator 1, according to FIG. 1, has a warning conductor 2, which is enclosed by a tube 3. This tube 3 extends from a loop 4 formed by the warning conductor 2 up to a plug 5.

The loop 4 serves to accommodate an insulation piece 6.1, as shown in FIGS. 2 to 4. This insulation piece 6.1 is preferably made of plastic. It has an arrow-shaped base element 7, consisting of two arrow-like plates 8.1 and 8.2 that leave a continuous groove 9.1 open between them, in which groove 9.1 makes a middle bridge 10 between the arrow-like plates 8.1 and 8.2

Two clip feet 11.1 and 11.2 extend downward from the base element 7, which are provided with snap tabs 12. The clip feet 11.1, 11.2 form a slit 13 between them, whose slit base 14 is widened, so that the flexibility of the clip feet 11.1, 11.2 is increased.

The method of function of the present invention is further described below and in conjunction with FIG. 2:

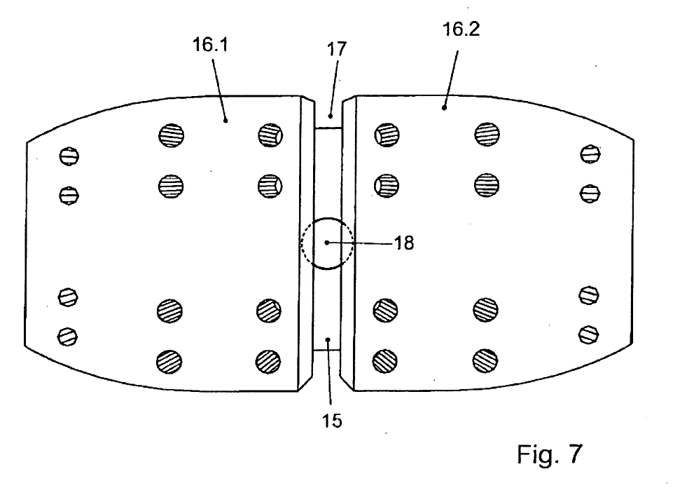

A lining support 15 of a brake is shown in FIG. 7, on which two friction linings 16.1 and 16.2 are positioned. Between the two friction linings 16.1 and 16.2, a gap 17 is formed, in which the lining support 15 is recognizable. The lining support 15 is provided with a recess 18 in this gap 17.

To install the wear indicator 1, the loop 4 is passed from the rear through the recess 18 of the lining support 15, tube 3 pushed back and compressed somewhat.

The tube 4 is now suspended in the insulation piece 6.1, tube 4 being suspended in groove 9.1. If the wear indicator 1 is now loosened, the tube 3 presses against the insulation piece 15 and pulls the loop 4 into groove 9.1. In this way, the loop 4 is held in position. The insulation piece 6.1 is then clipped into recess 18, the clip feet 11.1 and 11.2 briefly yielding, so that the snap tabs 12 can snap behind an edge of recess 18.

The height of the base element 7 is chosen, so that during wear of the friction lining 16.1 and 16.2, up to a predetermined dimension, wear of the upper tip of the base element 7, and then wear of the warning conductor 2, occurs, until the warning conductor 2 is interrupted, so that wear of the friction lining 16.1 and 16.2 is indicated.

The insulation piece 6.2 according to FIGS. 5 and 6 differs from those of FIGS. 2 to 4, in that a groove 9.2 does not run in a plane E in the insulation piece, but across it. The clip feet 11.3, 11.4 are also arranged across plane E and at a spacing from each other. The method of function, however, is the same as that of insulation piece 6.1.

| | |
|---|---|
| 1 | Wear indicator |
| 2 | Warning conductor |
| 3 | Tube |
| 4 | Loop |
| 5 | Plug |
| 6 | Insulation piece |
| 7 | Base element |
| 8 | Arrow-shaped plate |
| 9 | Groove |
| 10 | Middle bridge |
| 11 | Clip feet |
| 12 | Snap tab |
| 13 | Slit |
| 14 | Slit base |
| 15 | Lining support |
| 16 | Friction lining |
| 17 | Gap |
| 18 | Recess |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |
| E | Plane |

1-10. (canceled)

11. A device for monitoring and measuring the relative wear of a brake on a vehicle, comprising:
a warning conductor, wherein the warning conductor forms a loop during use;
a plug, wherein the plug is connectable to the warning conductor opposite the end of the loop;
a tube, wherein the tube encloses the warning conductor, such that the tube extends from the loop to the plug; and
an insulation piece, wherein the insulation piece accommodates the loop of the warning conductor, wherein said insulation piece mates with a lining support of a brake mechanism.

12. The device of claim 11, wherein the insulation piece further comprises:
a base, wherein the base includes a pair of opposing plates, disposed to comprise a continuous groove between said pair of opposing plates, and wherein the groove creates a middle bridge between the pair of opposing plates.

13. The device of claim 12, wherein the insulation piece further comprises a pair of clip feet, wherein the clip feet extend downwardly from the base, such that the clip feet form a slit to increase the flexibility of the feet.

14. The device of claim 13, wherein the clip feet further include snap tabs.

15. The device of claim 14, wherein the device is utilized with a brake having a lining support and a pair of friction linings positionable on said support, such that a gap is formed between the linings, and a recess is located in the gap for acceptance of the device.

16. A method for mounting the device of claim 15 on a brake having a lining support and a pair of friction linings positionable on said support, such that a gap is formed between the linings, and a recess is located in the gap, the steps comprising:
(a) passing the loop of the warning conductor through the recess in the gap of the lining support of the brake, such that the tube is suspended in the grove of the insulation piece;
(b) loosening the device so that the tube enclosing the warning conductor presses against the insulation piece;
(c) pulling the loop of the wear conductor into the groove of the base, thereby holding the loop in position; and
(d) clipping the insulation piece into the recess, thereby allowing the snap tabs to snap into the recess.

17. The method of claim 16 wherein the dimensions of the base of the insulation piece are selected to ensure interruption of the warning conductor once the friction linings have reached a predetermined amount of wear.

18. The method of claim 17, wherein the device is utilized with a drum brake.
